(19) United States
(12) Patent Application Publication
(10) Pub. No.: US 2026/0356267 A1
(43) Pub. Date: Nov. 12, 2026

(54) HEAD RESTRAINT FOR A VEHICLE SEAT

(71) Applicant: GRAMMER AKTIENGESELLSCHAFT, Ursensollen (DE)

(72) Inventor: Manuel BÖSL, Kümmersbruck (DE)

(21) Appl. No.: 19/128,530

(22) PCT Filed: Apr. 26, 2024
(86) PCT No.: PCT/DE2024/100379

§ 371 Date: May 8, 2025

(30) Foreign Application Priority Data
May 10, 2023 (DE) 10 2023 112 329.7

(51) Int. Cl. B60N 2/812; B60N 2/829

(52) U.S. Cl. CPC B60N 2/812; B60N 2/829

(57) ABSTRACT

A head restraint having a base on which a head rest is held, and having a holding device that supports the base on a vehicle seat. The base is height-adjustable relative to the holding device. The holding device has at least one central carrier part that is a molded part. A guide device for supporting and guiding the base along a guide path includes a first guide assigned to the carrier part and a second guide assigned to the base so that the base has degrees of freedom only in directions along the guide path and so that the base can be fixed relative to the carrier part in the set position by a fixing device.

The invention relates to a head restraint for a motor vehicle seat. Such a head restraint has holding means for supporting on a vehicle seat, which are connected to a base of the head restraint in a fixed or relatively movable manner. Such holding means are, for example, carrier rods or a carrier rod bracket.

The height can be adjusted, for example, by adjusting the holding means relative to the vehicle seat or, alternatively, by adjusting the base relative to the holding means. The head restraint can be adjusted to different height positions. A head rest is attached directly to the base, for example, or is guided on the base so that it can be adjusted horizontally.

DE 10 2019 117 990 A 1 discloses a seat with a head restraint, wherein the backrest of the seat has a carrier system. A carrier element comprising a mounting section 42 and a guide device 44 is associated with the head rest. The mounting section 42 is arranged in a fixed position on the carrier system. The head rest can be movably supported in the guide device and locked in the set position.

U.S. Pat. No. 8,573,693 B2 relates to a child seat for a vehicle. The seat is essentially constructed in two parts and comprises a lower seat part, on which a first guide and first locking means are formed, and a second seat part, to which the head rest is assigned and which has a second guide and second locking means.

It was the object of the invention to create a head restraint with a height adjustment, which can be produced cost-effectively and which is narrow in a rear region of the head restraint.

The object has been achieved by a head restraint having the features of claim 1.

The head restraint comprises a base one which a head rest is held. The head rest can be fixed to the base in a non-movable manner or be formed in one piece with it, or it can be supported on the base so that it can be adjusted in the x-direction, for example. The base can be supported on a vehicle seat using a holding device of the head restraint. The holding device is supported on a structure of the backrest, for example. The base is height-adjustable relative to the holding device. This means that it can be adjusted relative to the holding device in such a way that its vertical position changes.

The holding device comprises at least one central carrier part. A guide device for vertical adjustment comprises first guide means assigned to the carrier part and second guide means assigned to the base. The first guide means are designed to support and guide the base along a guide path in such a way that the base only has degrees of freedom in opposite directions along the guide path. The carrier part comprises, for example, form-fitting means as guide means, which prevent the base part from moving in any way other than along the movement path.

In the set position, the base can be locked relative to the guide path by means of a locking device. This means that it is held in the set position when the fixing device is fixed. The term “fixing” is to be understood here in the broadest sense and can mean, for example, locking as well as self-locking of a drive.

The carrier part has, for example, a holding region and a guide region. The holding region is used for direct or indirect support of the carrier part on the vehicle seat. The guide region comprises the first guide means for guiding the base. Further bearing means or holding means, e.g. for supporting a drive device for adjusting the base, can be formed on the guide region or on the holding region.

The carrier part has at least one region forming the guide path, which is circular, oval or quadrangular in cross-section to a longitudinal center axis, for example, wherein it can have a slot that extends parallel to the longitudinal center axis. The carrier part therefore has a high degree of stability and can limit the degrees of freedom that allow the base to move in directions other than the movement path.

The carrier part is, for example, a sheet metal part. The strength and bending stiffness requirements can easily be met with a sheet metal part. It is also possible to shape a sheet metal part using conventional methods. Alternatively, the carrier part can be a molded composite plastic part, for example. The molded plastic part is then reinforced with fibers, for example. Carbon fibers or glass fibers can be used for reinforcement.

If the carrier part is a sheet metal part, it can be designed as a bent part or as a stamped and bent part. The sheet metal part can be thus be formed cost-effectively and beads and bearing tabs can be added. The cost of a sheet metal part is also low.

The holding device can, for example, be fixed immovably to the vehicle seat, in particular to a backrest of the vehicle seat. Alternatively, the holding device can also be movable, in particular height-adjustable, relative to the backrest.

The holding device comprises the carrier part and carrier rods, which are connected to the carrier part and can be supported on a backrest of the vehicle seat. The carrier part according to the invention can then be used without having to modify the usual structures of the backrest to accommodate carrier rods in guide sleeves.

The carrier rods are firmly connected to the carrier part by means of a connection, for example. Any suitable type of connection can be considered here. For example, the connection is a welded connection if the carrier part is designed as a sheet metal part.

For example, the base forms a sliding guide with the carrier part. In this case, the carrier part provides sliding surfaces. The sliding surfaces can be formed by the carrier part itself or by sliding bearings attached thereto.

The base and/or the carrier part have, for example, at least one sliding bearing for sliding guiding of the base on the carrier part. Alternatively or additionally, other bearings, e.g. roller bearings, can also be used to support the base on the carrier part. The carrier part forms, for example, fixing means for fixing at least parts of a gear for height adjustment. Such fixing means can be bearing seats, recesses, etc.

The fixing means comprise, for example, a tab cut free from the carrier part and protruding from a region adjacent to the free cut. In this way, separate parts for fixing can be dispensed with. It must be ensured that the stability of the carrier part continues to fulfil the requirements.

For example, first guide means are formed on the carrier part, which co-operate with second guide means on the base to guide the base in the z-direction. The guide means are formed, for example, by the sliding surfaces of the carrier part and the base. The first guide means are formed, for example, by regions of the carrier part or by at least one separate guide part held on the carrier part.

The second guide means are molded onto the base, for example. If, for example, the base is designed as a plastic part, the second guide means can be molded on easily. At least one separate guide means can also be held on the base.

The fixing device is formed, for example, by a locking device with first locking means assigned to the carrier part and second locking means assigned to the base, which can be releasably moved into engagement. Alternatively, the fixing device is formed, for example, by a motor-driven adjustment gear with self-locking. In this case, the gear holds the base in the set position when the gear is stationary, i.e. when it is not being moved.

Exemplary embodiments of the invention are described in the following figure description, additionally with reference to the drawings. For the sake of clarity—also insofar as different embodiments are concerned—identical or comparable parts or elements or regions are designated with the same reference numerals, sometimes with the addition of lowercase letters.

Features described only in relation to one embodiment may also be provided in any other embodiment of the invention within the scope of the invention. Such modified embodiments—even if not shown in the drawings—are covered by the invention.

All disclosed features are essential to the invention in themselves. The disclosure of the application hereby also includes in full the disclosure content of associated priority documents (copy of the prior application) as well as cited publications and the described prior art devices, also for the purpose of including individual or several features of these documents in one or several claims of the present application.

In the schematic figures:

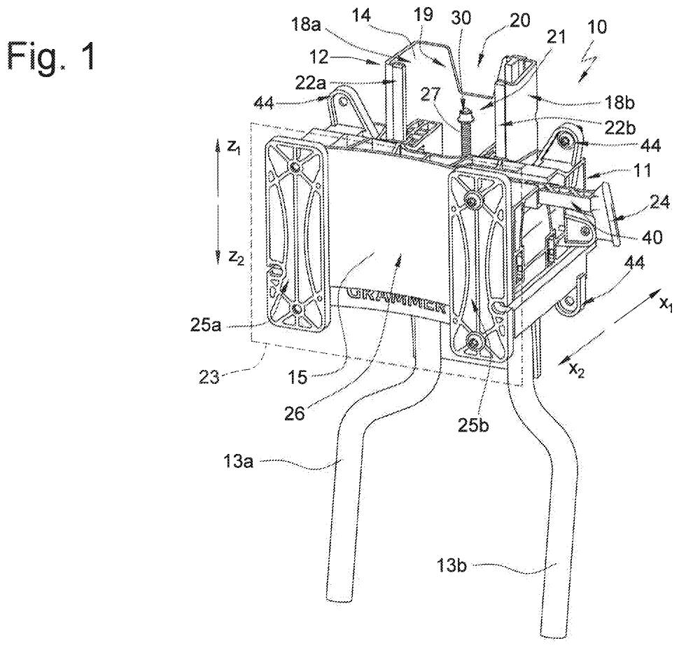

FIG. 1 shows a perspective view of the head restraint from diagonally in front, wherein panelling parts and upholstered parts of the head restraint as well as parts of the head rest are not shown, wherein a base is in a lower end position,

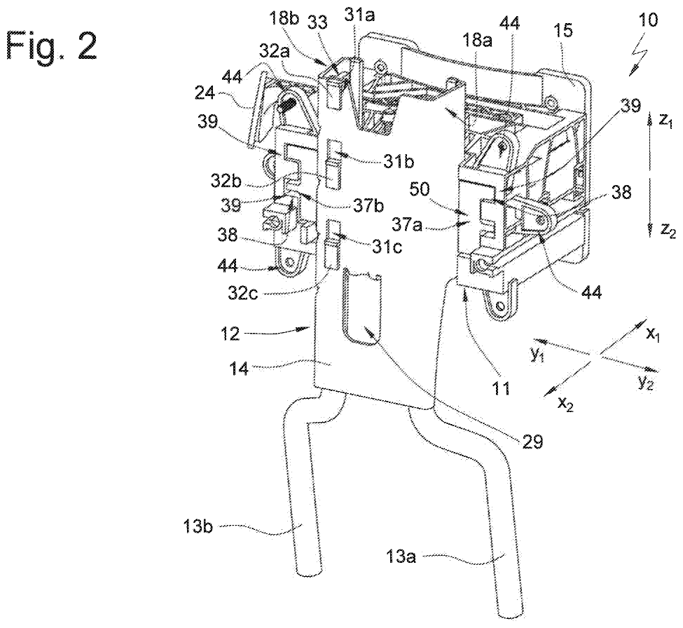

FIG. 2 shows a perspective view based on FIG. 1 from diagonally behind,

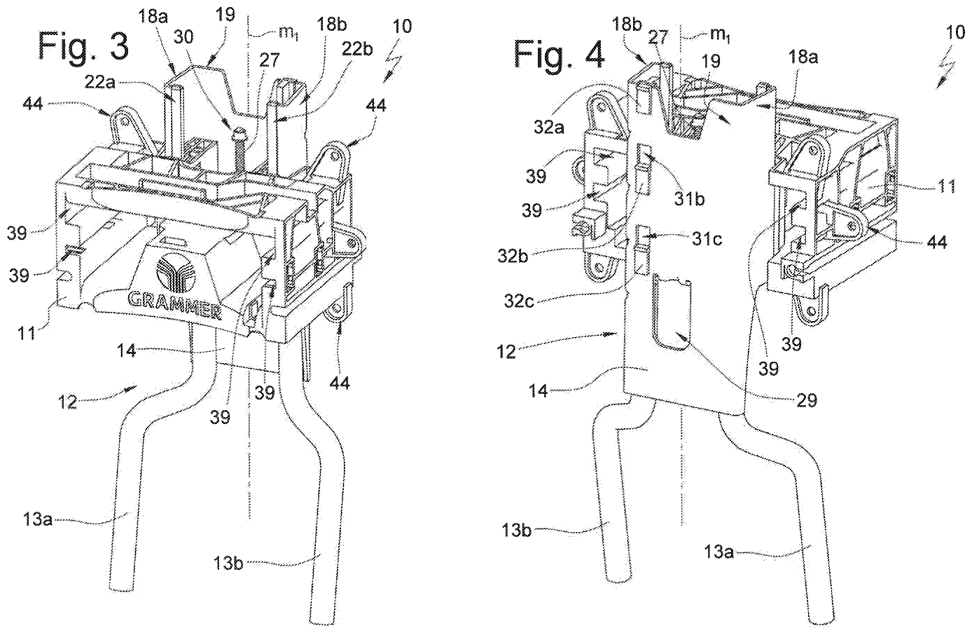

FIG. 3 shows a perspective view based on FIG. 1 from diagonally in front, wherein the head rest as a whole is not shown,

FIG. 4 shows a perspective view of the head restraint according to claim 3 from diagonally behind,

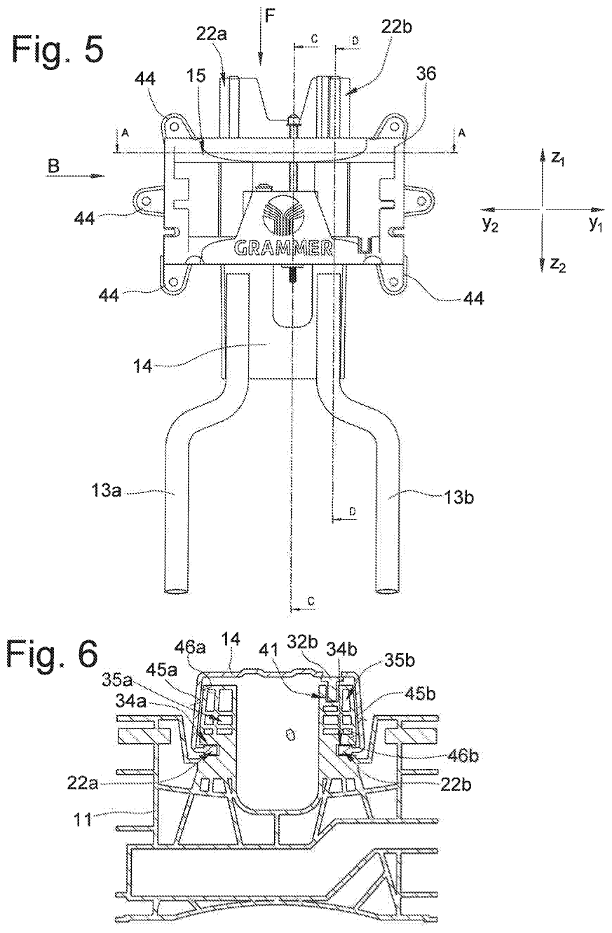

FIG. 5 shows a front view of the head restraint, wherein the carrier part is in the lower end position,

FIG. 6 shows a sectional view according to the sectional line A-A in FIG. 5,

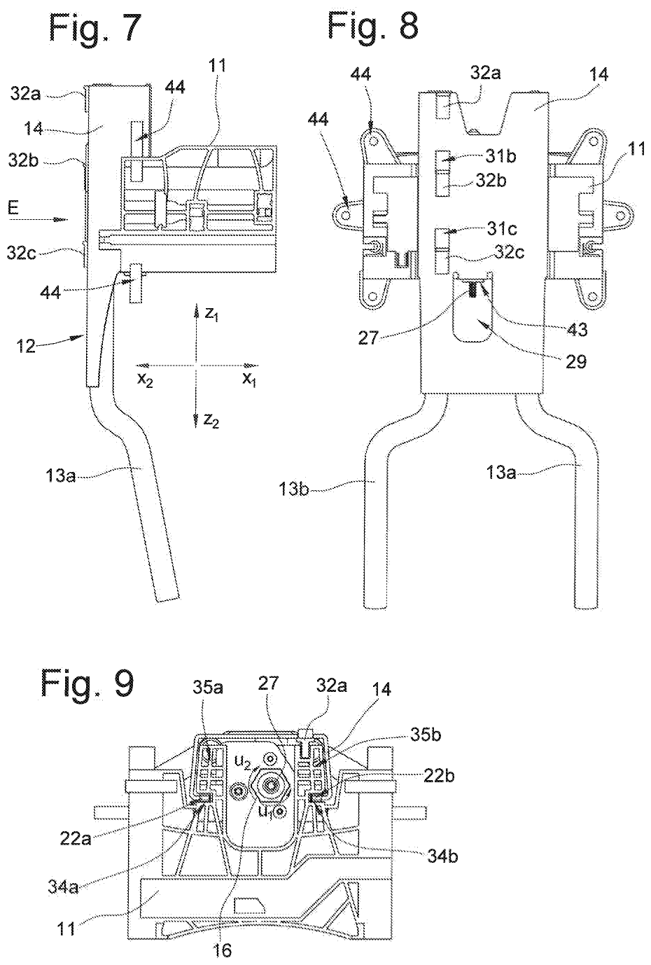

FIG. 7 shows a side view according to the viewing arrow B in FIG. 5,

FIG. 8 shows a rear view according to the viewing arrow E in FIG. 7,

FIG. 9 shows a plan view according to the viewing arrow F in FIG. 5,

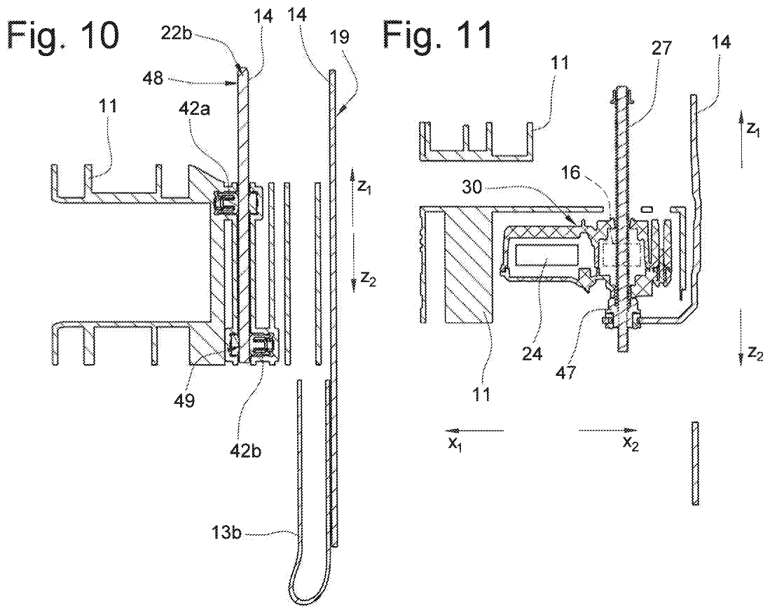

FIG. 10 shows a sectional view according to the sectional line D-D in FIG. 5,

FIG. 11 shows a sectional view according to the sectional line C-C in FIG. 5,

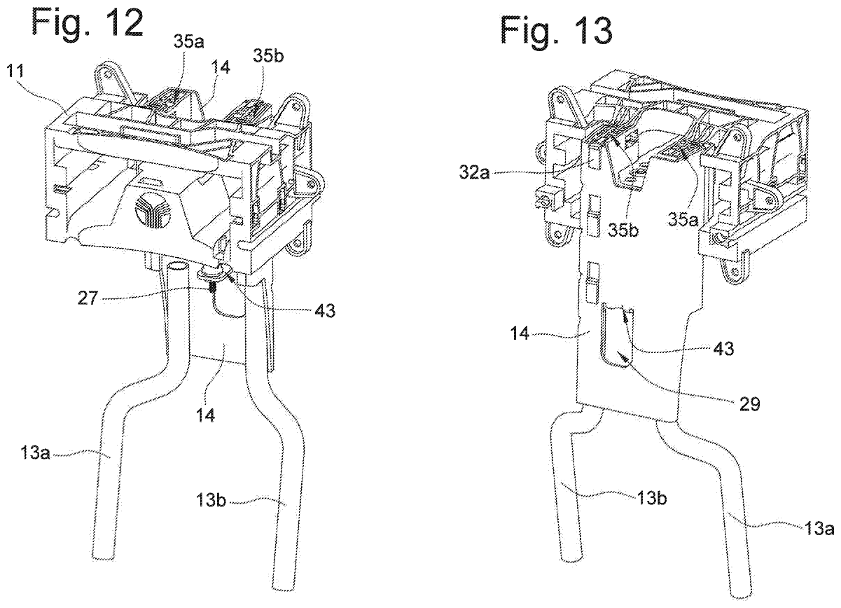

FIG. 12 shows a perspective view based on FIG. 3 from diagonally in front, wherein the base is in an upper end position,

FIG. 13 shows a perspective view based on FIG. 4 from diagonally behind, wherein the base is in the upper end position,

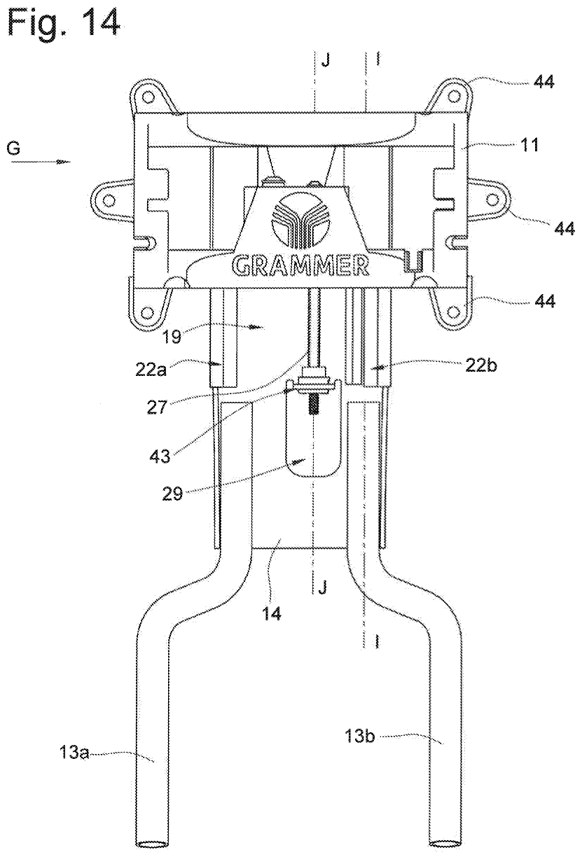

FIG. 14 shows a front view of the head restraint based on FIG. 5, wherein the base is in an upper position,

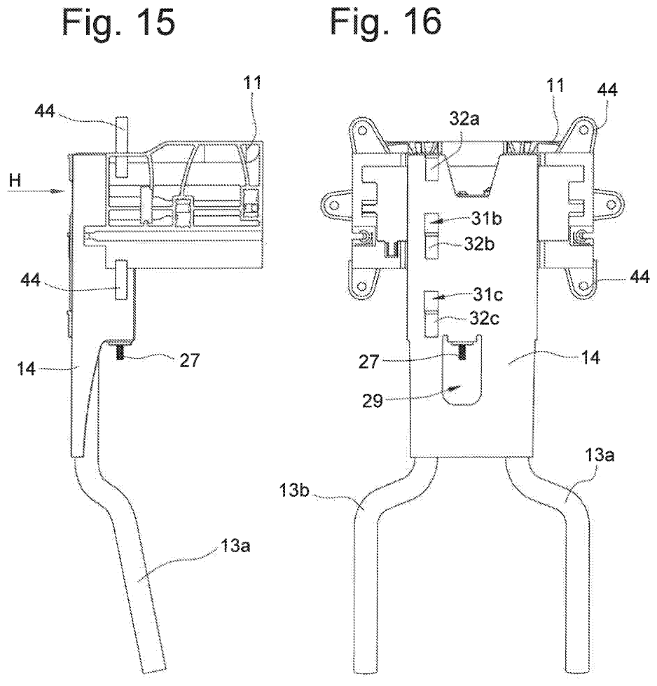

FIG. 15 shows a view according to the viewing arrow G in FIG. 14,

FIG. 16 shows a view according to the viewing arrow H in FIG. 15,

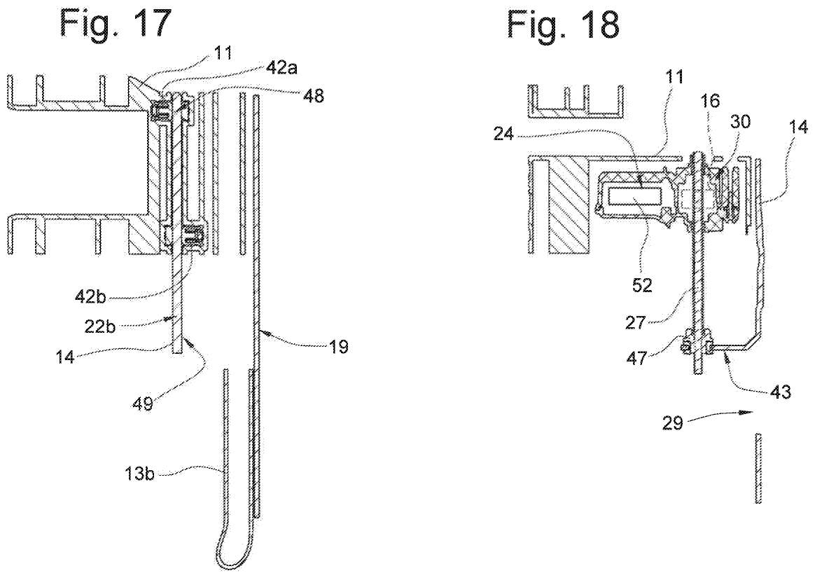

FIG. 17 shows a sectional view according to the sectional line I-I in FIG. 14,

FIG. 18 shows a sectional view according to the sectional line J-J in FIG. 14,

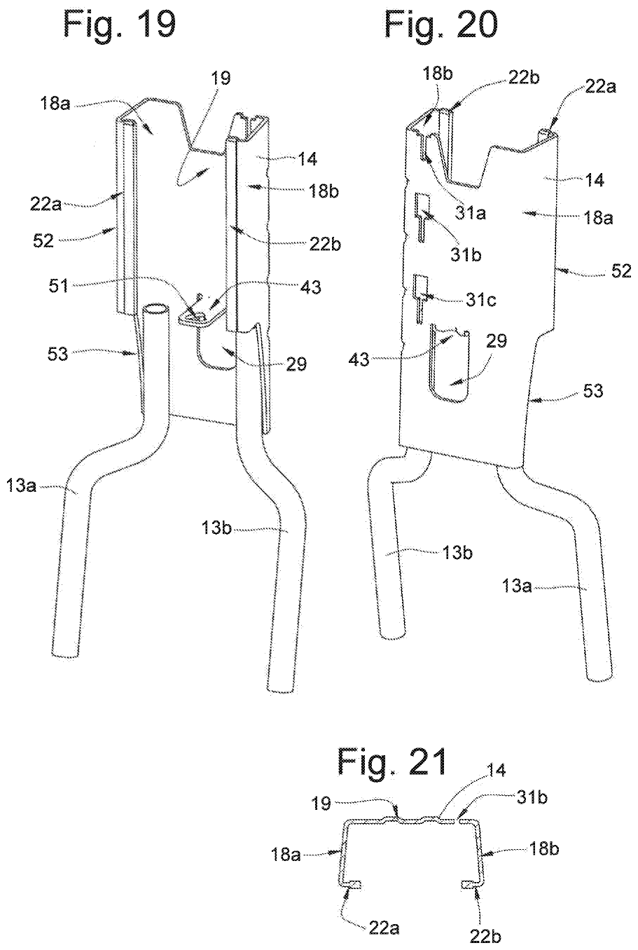

FIG. 19 shows a perspective view of the holding device from diagonally in front,

FIG. 20 shows a perspective view of the holding device from diagonally behind,

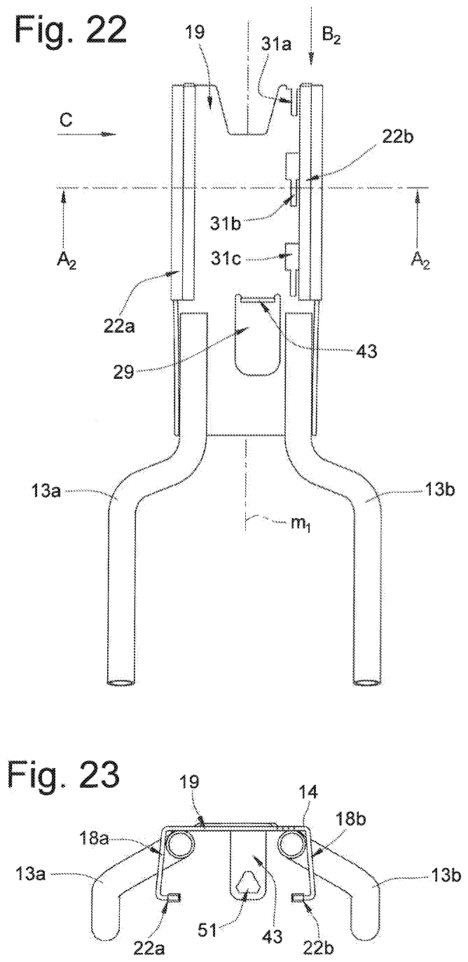

FIG. 21 shows a sectional view according to the sectional line A2-A2 in FIG. 22,

FIG. 22 shows a front view of the holding device,

FIG. 23 shows a plan view of the holding device according to the viewing arrow B2 in FIG. 22,

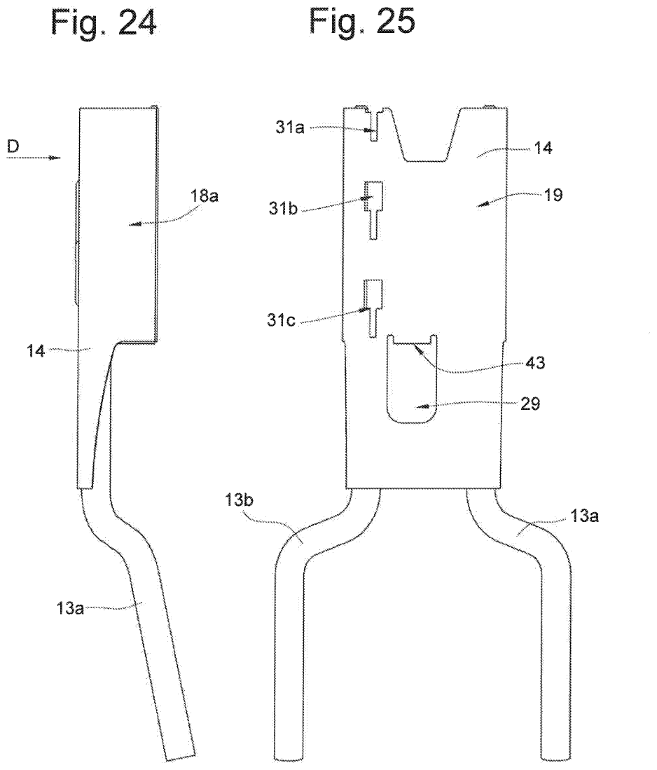

FIG. 24 shows a side view according to the viewing arrow C in FIG. 22,

FIG. 25 shows a rear view according to the viewing arrow D in FIG. 24.

In the figures, directions of a standard coordinate system with x-, y- and z-axes are used, in which the axes are perpendicular to each other. The axes are assigned to the directions as is usual in the automotive industry, i.e. the x-axis extends horizontally in the direction of travel, the y-axis in lateral directions and the z-axis in vertical directions.

According to FIG. 1, a perspective view of the head restraint 10 is shown, wherein parts of the paneling and the upholstery as well as parts of a head rest 15 are not shown. The head restraint 10 comprises a base 11, which can be supported on a vehicle seat using a holding device 12. In FIGS. 1 to 11, the base 11 is shown in the lowest position. The holding device 12 comprises carrier rods 13a and 13b, as well as a carrier part 14 to which the carrier rods 13a and 13b are connected. In the present example, a welded connection was used to fix the carrier rods 13a and 13b to the carrier part 14, but any suitable fixing methods can be considered as an alternative. By providing the carrier part 14 with carrier rods 13a and 13b, the usual support in the backrest—e.g. by means of guide sleeves—can be used. Alternatively, the carrier part 14 could also be fixed to the structure of the backrest without carrier rods 13a and 13b.

As can be seen in FIG. 1, the carrier part 14 is designed as a c-shaped component in cross-section. In other words, the carrier part 14 is approximately rectangular or slightly trapezoidal in cross-section with two opposing side walls 18a and 18b and a rear wall 19. A front wall opposite the rear wall is provided with a wide slot 21 along a longitudinal center line m1, so that only projections 22a and 22b are formed on the front wall, which run approximately parallel to the rear wall 19.

In FIG. 2, an opening 29 is shown in a lower area of the rear wall 19 of the carrier part 14, the function of which is explained below. In addition, in FIG. 2, openings 31a 31b and 31c are formed in the rear wall 19 of the carrier part 14. These are used to fix a guide part 32. The guide part 32 is fixed to a reveal of the respective opening 31a, 31b and 31c and has a protrusion 33 that protrudes in the direction x1.

As an alternative to the guide part 32, the carrier part 14 could also have a bulge in the direction x1 that extends in the Z-direction and engages in the guide groove 41 of the base 11. Other suitable guides can also be used.

In addition, the head restraint 10 has an adjustment device 40, mentioned here only in passing and not essential for the invention, for adjusting the head rest 15 in the x-direction. The head rest 15 comprises two extensions 37a and 37b, which are each provided with guide rods 38. In FIGS. 1 and 2, groove-shaped guide slots 39 of the base 11 can be seen. Each guide rod 38 engages in a guide slot 39 and can be moved therein in the directions x1 and x2. The head rest 15 is secured with this support against movement in the directions y1 and y2 and in the directions z1 and z2, wherein movement in the directions x1 and x2 is possible.

A holding part 25a and 25b is formed on each extension 37a and 37b. The two holding parts 25a and 25b are connected to one another by means of a traverse 26. A contact plate 23, indicated only by a dashed line in FIG. 1, is formed on the holding parts 25a and 25b. The head rest 15 can be releasably locked in different x-positions by means of the actuation 24 of the locking device 40, which is only partially shown. According to an alternative embodiment, the head contact plate 23 can also be held on the base 11 without an adjustment function in the x-direction. FIG. 3 ff. show the head restraint without the head rest 15.

FIGS. 3 and 4 correspond to FIGS. 1 and 2, wherein the head rest 15 is not shown. The base 11 is in a lower end position. According to FIG. 4, the base 11 comprises flange regions 44 for fixing a rear cover part (not shown).

A drive device 30 (see FIG. 3) comprises a motor 17 (not visible in FIG. 3) and a spindle 27. In this case, the spindle 27 is firmly connected to the carrier part 14 by a bearing part 47, and a spindle nut 16 with an internal thread is rotatably supported in the base 11 and rotates on an external thread of the spindle 27 in order to move the base 11 in the directions z1 and z2. When the spindle nut 28 is rotated in a first direction u1, the head rest 15 is moved upwards in the direction z1 and when it is rotated in an opposite second direction u2, the head rest 15 is moved downwards in the direction z2 (see, for example, FIGS. 3 and 4).

As can be seen in FIG. 6, the base 11 comprises slot-shaped recesses 34a and 34b, into which the projections 22a and 22b engage. Guide jaws 35a and 35b of the base 11 engage behind the projections 22a and 22b. The projections 22a and 22b form first guide means and the recesses 34a and 34b form second guide means of a guide device 50 41 within the meaning of the invention. In FIG. 6 it can be seen that an outer surface 45a of the guide jaw 35a interacts with an inner surface 46a of the carrier part 14 and an outer surface 45b of the guide jaw 35b interacts with an inner surface 46b of the carrier part 14 and forms a sliding bearing. The base 11 forms a guide device 20 with the carrier part 14, with which the base 11 is movably guided in the directions z1 and z2.

As can also be seen in FIG. 6, the protrusion 33 engages in a guide groove 41 of the base 11. The guide part 32 also prevents the base 11 from rotating about the x-axis. The protrusion 33 of the guide part 32 forms first guide means and the guide groove 41 forms second guide means within the meaning of the invention.

FIG. 7 shows a side view of the head restraint. In the present example, the base 15 has a relatively large extension in the x-direction due to the type of sliding guide means for the head rest 15. However, it is conceivable that the base 11 can be designed with a small extension in the x-direction, e.g. if the head rest 15 is immovable relative to the base 11.

In the rear view as shown in FIG. 8, the support of the spindle 27 can be seen on a tab 43, which in this example is cut out of the carrier part 14 and bent over. In the top view of the head restraint 10 as shown in FIG. 9, the guide of the base 11 on the carrier part 14 can be seen.

The base 11 is provided with sliding bearings 42a and 42b, which are arranged at a distance from each other in the z-direction according to FIG. 10 and co-operate with the projection 22b. Two further sliding bearings 42a and 42b of the base 11, which cannot be seen in FIG. 10, interact with the projection 22a. According to FIG. 10, the base 11 is in the lower end position, wherein the sliding bearing 42b is at a lower end region 49 of the projection 22b. The fixing of the carrier rod 13b to the carrier part 14 can also be seen.

The sectional view according to FIG. 11 shows the spindle 27, wherein the motor 17 and the spindle nut 16 can be seen. The height of the base 11 is adjusted by means of the electric motor 17, which can rotate the spindle nut 16 in different directions u1 and u2, so that it moves together with the base 11 relative to the carrier part 14 on the spindle 27 in the direction z1 or in the direction z2.

According to FIG. 11, the spindle 27 is supported on the tab 43, which has been cut free from the carrier part 14 and protruding, wherein the opening 29 has been created. Alternatively, the tab 43 could also be manufactured separately and fixed to the carrier part 14. According to FIG. 13, the spindle 27 is accommodated in the bearing part 47, which in turn is held on the tab 43 and engages through an opening 51 of the tab 43.

In FIGS. 12 to 18, the base 11 is moved in the direction z1 to the upper end position in relation to FIGS. 1 to 11. The base 11 is held in the respective position by the self-locking threads of the spindle 27 and the spindle nut 16. An additional locking mechanism is therefore not provided or necessary in this exemplary embodiment.

FIGS. 12 and 13 are perspective views as shown in FIGS. 3 and 4, wherein the head rest 15 is in an upper end position. FIG. 14 shows a front view of the head restraint 10 according to FIGS. 12 and 13.

FIGS. 15 and 16 are views corresponding FIGS. 7 and 8, wherein the base 11 is in the upper end position. In FIG. 17 is can be seen that in the upper end position the upper sliding bearings 42a are in contact with an upper end region 48 of the tabs 22a and 22b. As shown in FIG. 18, the base 11 with the spindle nut 28, which is only shown schematically, is arranged at an upper end region of the spindle 27.

FIG. 19 shows the tab 43 of the carrier part 14 and the opening 51 formed therein for receiving the bearing part 47. FIGS. 19 and 20 also show the guide region 52 and the holding region 53 of the carrier part 14.

1-15. (canceled)

16. A head restraint, comprising: a base in which a head rest is held; a holding device that supports the base on a vehicle seat, wherein the base is height-adjustable relative to the holding device, wherein the holding device comprises at least one central carrier part that is a molded part; and a guide device that supports and guides the base along a guide path, wherein the guide device includes a first guide assigned to the carrier part and a second guide assigned to the base so that the base has degrees of freedom only in directions along the guide path and so that the base is fixable relative to the carrier part in a set position by a fixing device.

17. The head restraint according to claim 16, wherein the carrier part has at least one guide region forming the guide path and has a holding region.

18. The head restraint according to claim 16, wherein the carrier part is a sheet metal part or a molded plastic part.

19. The head restraint according to claim 18, wherein the sheet metal part is a bent part or a stamped-bent part.

20. The head restraint according to claim 16, wherein the holding device is supported immovably relative to the backrest.

21. The head restraint according to claim 16, wherein the holding device comprises the carrier part and carrier rods that are connected to the carrier part by a connection and are supportable on a backrest of the vehicle seat.

22. The head restraint according to claim 21, wherein the connection is a welded connection.

23. The head restraint according to claim 16, wherein the base forms a sliding guide with the carrier part.

24. The head restraint according to claim 23, wherein the base and/or the carrier part has at least one sliding bearing for sliding guidance of the base on the carrier part.

25. The head restraint according to claim 16, wherein the carrier part forms fixing means for fixing at least parts of a drive device for height adjustment.

26. The head restraint according to claim 25, wherein the fixing means comprise a tab cut free from the carrier part and protruding from a region adjacent to the free cut.

27. The head restraint according to claim 16, wherein the first guide is formed by regions of the carrier part or by at least one separate guide part.

28. The head restraint according to claim 16, wherein the second guide is molded onto the base.

29. The head restraint according to claim 16, wherein the fixing device is a locking device with first locking means associated with the carrier part and second locking means associated with the base or by a motor-driven drive device with an adjusting gear with self-locking.

30. The head restraint according to claim 16, wherein the carrier part is polygonal, round, oval or C-shaped in cross-section relative to a longitudinal center axis.
